(19) United States
(12) Patent Application Publication
(10) Pub. No.: US 2017/0193468 A1
(43) Pub. Date: Jul. 6, 2017

(54) PEER-TO-PEER MOBILE TRANSACTION DEVICE

(71) Applicant: PAYPAL, INC., San Jose, CA (US)

(72) Inventors: Prakash Tukaram Chougule, San Jose, CA (US); Eric Byungho Min, San Jose, CA (US)

(21) Appl. No.: 14/985,306

(22) Filed: Dec. 30, 2015

(51) Int. Cl. G06Q 20/10; H04L 29/06; G06Q 20/22; G06F 3/0487; G06Q 20/40; G06F 3/0484; G06F 3/0481; H04L 29/08; G06Q 20/32

(52) U.S. Cl. CPC G06Q 20/102; H04L 67/1061; H04L 65/4076; G06Q 20/223; G06Q 20/3278; G06Q 20/401; G06F 3/0484; G06F 3/0481; G06F 3/0487

(57) ABSTRACT

Peer-to-peer mobile transaction devices are provided with a mobile peer-to-peer transaction application to enable mobile devices to perform action, such as transfer money, between each other via direct wireless communication between the mobile devices, such as Bluetooth communication. The mobile peer-to-peer transaction application may allow dynamic and direct transactions between nearby mobile devices via direct wireless communication. For example, the mobile peer-to-peer transaction app may allow friends to easily split a restaurant bill using their mobile devices.

### BACKGROUND

The present invention generally relates to a peer-to-peer mobile transaction device and systems and methods for facilitating peer-to-peer payment transactions between mobile devices.

With the proliferation of electronic commerce, increasing numbers of payment transactions are made electronically, such via the internet. In particular, a payment service provider, such as PayPal, Inc. of San Jose, Calif. may provide services to facilitate a payment transaction between a payer and a payee. A payer or a payee may use a mobile communication device to connect, via the internet, to the payment service provider's server to request a payment transaction. However, mobile communication devices of the payer and payee rely on a connection to the server of the payment service provider to implement transactions. For example, when the mobile communication device is in a remote area where no wireless communication signals are available for the mobile communication to connect to the internet, the mobile communication device may not be able to connect to the internet to conduct electronic payment transactions. Thus, there is a need for a system or method that facilitates electronic payment transactions directly between mobile communication devices of the payer and the payee.

### BRIEF DESCRIPTION OF THE FIGURES

FIG. 1 is a block diagram of a networked system suitable for implementing peer-to-peer mobile transactions according to an embodiment.

FIG. 2 is a flowchart showing a process for initiating a peer-to-peer mobile payment transaction according to one embodiment.

FIG. 3 is a flowchart showing a process for participating in a peer-to-peer mobile payment transaction according to one embodiment.

FIG. 4 is a block diagram of a computer system suitable for implementing one or more components in FIG. 1 according to one embodiment.

FIG. 5 is a diagram illustrating user interface for implementing peer-to-peer mobile payment transaction according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, mobile devices are provided with a mobile peer-to-peer application (app) that enables the mobile devices to conduct transactions, such as transfer money, between each other via direct wireless communication between the mobile devices, such as Bluetooth communication. The mobile peer-to-peer application may allow dynamic and direct payment transactions between nearby mobile devices via short-range wireless communication (e.g., Bluetooth, Wi-Fi Direct, ZigBee, infrared, Li-Fi, NFC). For example, the mobile peer-to-peer payment app may allow friends to split a restaurant bill using their mobile devices. In particular, the mobile peer-to-peer application may allow payments among nearby users who are not previously connected to each other in any way, such as not previously connected through contact lists, social network sites, or etc. Thus, a payment group may be determined dynamically ad hoc in real time.

In an embodiment, a user may use the mobile peer-to-peer app to initiate and establish a payment group. In particular, the user's device may broadcast a Bluetooth signal to nearby mobile devices to invite nearby users to join the payment group. The nearby mobile devices may detect the Bluetooth signal and the nearby users may decide to join the payment group. The user device may display nearby app users in a list for the user to initiate a payment group. The user may select the intended participants in the payment group from the list. The list of users may be limited to the intended participants via certain means. In particular, the user may communicate, e.g., verbally, a password or a code, to the intended nearby users. The password or the code may be used by the nearby users to join the payment group. Thus, the user may restrict the payment group to only the user's friends or the intended nearby users. Other means for restricting the payment group may include a particular gesture performed by the users, such as touch gestures on a touch screen, shaking the mobile devices, bumping the mobile devices to each other, or the like. In another example, the intended users may be required to perform certain gestures together or simultaneously within a certain period of time to join the payment group. Thus, the payment group may be restricted for only the intended nearby users.

In an embodiment, the mobile peer-to-peer app may provide a user interface on the mobile devices of the users to determine payment transactions and arrangement. For example, the user interface may display users who have currently joined the payment group. The user interface may allow the users to coordinate and determine payment transactions and arrangement. For example, the users may designate one person to pay a restaurant bill and the other users may pay the person.

In an embodiment, the mobile peer-to-peer app may provide a user interface for the users to determine payment arrangements via various options or games. For example, the users may split a bill evenly among the users, or may split a bill by a certain priority, such as by age or the like. The users may split a bill by lottery or by playing a game, such as spin a wheel. In another embodiment, the users may decide to determine payment arrangements based on payment history, such as a group of users may decide to take turns paying for lunch.

After the payment arrangement is finalized, the mobile peer-to-peer app may facilitate payment transactions among the users in the payment group. In an embodiment, requests for the payment transactions may be communicated to the payment service provider who may debit from the respective payers' accounts and credit the corresponding payees' accounts. In another embodiment, when no network connection is available to the payment service provider, the payment requests or records may be stored temporarily on the mobile devices of the users and may later be uploaded to the payment service provider for processing when network connection becomes available. Thus, the mobile peer-to-peer app may allow users to conduct peer-to-peer payments via direct Bluetooth communication among mobile devices even when no network connection to the payment service provider is available. When the payment requests are pending, the payees may send reminders/notifications to payers about the pending payment requests. The reminders may be sent when the payer's device does not have internet connection for longer than expected. Payee may be able to send text-messages to a payer to remind the payer about the pending payments, such that the payer may be reminded to connect to the internet. In some embodiments, the peer-to-peer transaction app on the payer's device may automatically generate and communicate reminders to the payer's device.

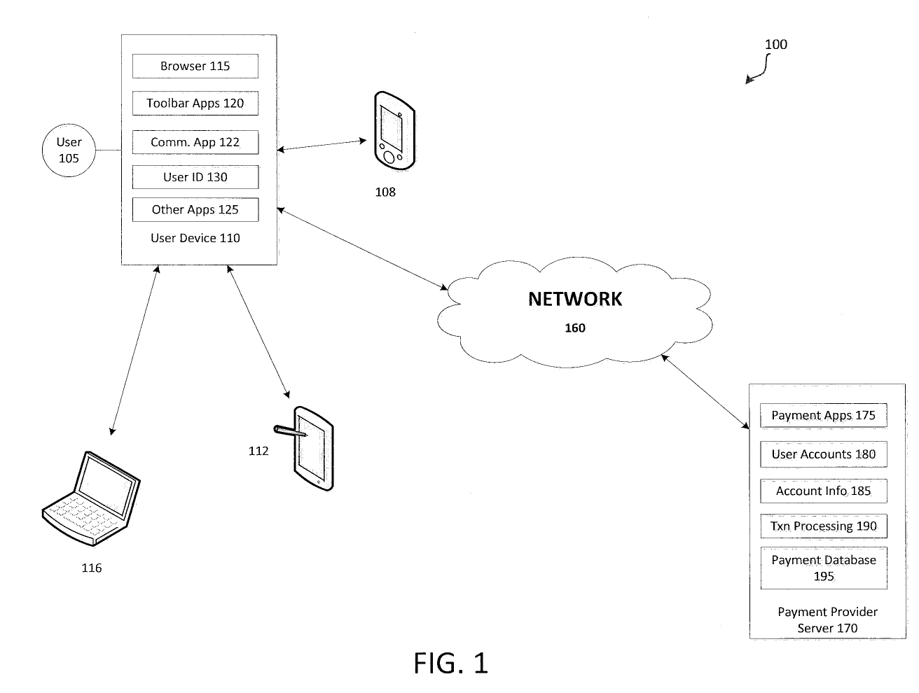

FIG. 1 is a block diagram of a networked system 100 suitable for implementing peer-to-peer mobile transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, other user devices 108, 112, and 116, and a payment provider server 170 in communication over a network 160. Payment provider server 170 may be maintained by a payment service provider, such as PayPal, Inc. of San Jose, Calif. A user 105 may utilize user device 110 to perform payment transactions using payment provider server 170. A user 105 may utilize user device 110 to initiate a peer-to-peer mobile payment transaction, receive a peer-to-peer mobile payment transaction, receive a transaction approval request, or reply to the request. For example, the user device 110 may conduct peer-to-peer payment transactions with user devices 108, 112, and 116 via Bluetooth (or other short-range wireless) communication.

Communication devices 108, 112, and 116 may have similar functions and/or components as the user device 110 and may similarly be connected to the payment provider server 170 via the network 160. The communication devices 108, 112, and 116 may be located near the user device 110, such as within a Bluetooth broadcast range of the user device 110.

User device 110, payment provider server 170, and communication devices 108, 112, and 116 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over the network 160.

User device 110 may be implemented using any appropriate hardware and software configured for wired and/or wireless communication in the system 100. For example, in one embodiment, the user device 110 may be implemented as a personal computer (PC), a smart phone, wearable device, laptop computer, and/or other types of computing devices capable of transmitting and/or receiving data, such as an iPad™ from Apple™.

The user device 110 may include one or more browser applications 115 which may be used, for example, to provide a convenient interface to permit user 105 to browse information available over the network 160. For example, in one embodiment, browser application 115 may be implemented as a web browser configured to view information available over the network 160, such as a user account for setting up a shopping list and/or merchant sites for viewing and purchasing products and services. User device 110 may also include one or more toolbar applications 120 which may be used, for example, to provide client-side processing for performing desired tasks in response to operations selected by the user 105. In one embodiment, toolbar application 120 may display a user interface in connection with browser application 115.

The user device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over the network 160, or other types of applications.

Applications 125 may also include email, texting, voice and IM applications that allow user 105 to send and receive emails, calls, and texts through the network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider.

User device 110 may include a communications application 122, with associated interfaces, that enables user device 110 to communicate within system 100. For example, the communications application 112 may be configured to manage and implement wired communication, such as Ethernet communication and/or telephone landline communication, and wireless communication, such as WiFi communication, Bluetooth communication, cellular voice and/or data communication, Near-Field Communication (NFC), and the like.

User device 110 may download a mobile app, such as a payment app, from payment provider server 170. In some embodiments, the mobile app may be available for download from a public app market. The mobile app may provide functions that allow the user device 110 to facilitate and/or implement peer-to-peer mobile payment transactions with other nearby mobile devices. In particular, the peer-to-peer mobile payment transactions may be implemented via short-range wireless communication, such as Bluetooth, Wi-Fi Direct, ZigBee, infrared, Li-Fi, NFC, or other suitable technologies. For example, Bluetooth communication may be established between the user device 110 and other nearby by mobile devices, such as user devices 108, 112, and 116.

Bluetooth communication is a wireless communication technology standard using short-wavelength UHF radio waves in the ISM band from 2.4 to 2.495 GHz. Bluetooth communication typically may be used by portable or mobile devices to communication with nearby devise. Bluetooth communication utilizes frequency-hopping spread spectrum in which data is divided and transmitted in data packets. The data packets may be transmitted via one or more of 79 Bluetooth channels, each with 1 MHz of bandwidth. Bluetooth communication may perform 1600 hops per second with adaptive frequency-hopping enabled. Bluetooth low energy (BLE) uses 2 MHz spacing and may accommodate about 40 channels.

Bluetooth communication is a packet-based protocol with master-slave structure. One master may communicate with up to seven slaves in a piconet. All devices may be synchronized and share with a mater device's clock. Data packet exchange may be based on the shared clock, as defined by the master device, which may tick at 312.5 μs intervals. Two clock ticks make up a slot of 625 μs and two slots make up a slot pair of 1250 μs. In a single-slot packets arrangement, the master device may transmit in even slots and may receive in odd slots. The slave devices may receive in even slots and may transmit in odd slots. Bluetooth communication may have a broadcast range of about 10-15 meters.

A Bluetooth profile for peer-to-peer mobile payments may be established that may define the application and format for mobile devices to implement peer-to-peer mobile payment with each other. The peer-to-peer mobile payment profile may define settings and parameters for establishing and implementing Bluetooth communication to facilitate peer-to-peer mobile payments.

User device 110 also may include applications that collect location data using Global

Positioning System (GPS) to identify a location of user device 110. User device 110 may have a magnetometer configured to detect a moving or traveling direction of user device 110. Other means for collecting location data, such as WiFi devices, Near-Field Communication (NFC) devices, or the like also may be included in user device 110 for determining a location of user device 110. Thus, user device 110 may determine a current location of user device 110 and track a traveling direction of the user device 110 based on the collected location data.

Payment provider server 170 may be maintained, for example, by an online payment service provider which may provide peer-to-peer payments between users. In this regard, payment provider server 170 may include one or more payment applications 175 which may be configured to interact with user devices over the network 160 to facilitate the purchase of goods or services, communicate/display information, and process payment requests received from users.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105.

A transaction processing application 190, which may be part of payment application 175 or separate, may be configured to receive information from user device 110 and/or user devices 108, 112, and 116 for processing and storage in a payment database 195. Transaction processing application 190 may include one or more applications to process information from user 105 for processing a peer-to-peer mobile payment using various selected funding instruments. As such, transaction processing application 190 may store details of a peer-to-peer payment arrangement from individual users, including funding source used, credit options available, etc. Payment application 175 may be further configured to determine the existence of and to manage accounts for user 105, as well as create new accounts if necessary.

User devices 108, 112, and 116 may be located within the wireless broadcast range of the user device 110. As such, user devices 108, 112, and 116 may detect and connect with user device 110 to form a peer-to-peer communication network for implementing peer-to-peer mobile payments. When the user 105 initiates a payment group at the user device 110, the user device 110 may broadcast an invitation to join the payment group to user devices 108, 112, and 116. One or more of the user devices 108, 112, and 116 may join the payment group to facilitate peer-to-peer mobile payments. For example, the user 105 may share information about the payment group verbally with the intended participants. The intended participants may then use the information to join the payment group.

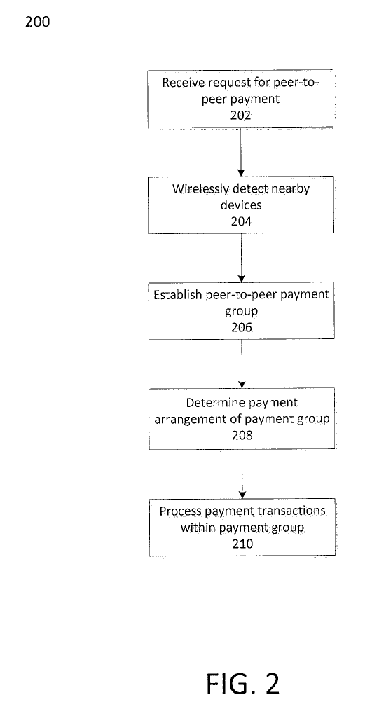

FIG. 2 is a flowchart showing a process 200 for initiating a peer-to-peer mobile payment transaction according to one embodiment. The process 200 for initiating a peer-to-peer mobile payment may be executed by one of the user devices 110, 108, 112, and 116. For example, each user device may download a peer-to-peer mobile payment application from the payment provider server 170 or from a public mobile app marketplace, such as APPLE APP STORE, GOOGLE PLAY STORE, or the like. The peer-to-peer payment application may register the user device to the payment provider server 170 and may enable the user device to utilize the peer-to-peer payment service at the payment provider server 170. The peer-to-peer payment application also may execute the process 200 to initiate a peer-to-peer mobile payment transaction with nearby user devices. As an example, the following description assumes that the user 105 uses the user device 110 to initiate a peer-to-peer mobile payment transaction.

At step 202, the user device 110 may receive a request from the user 105 for peer-to-peer payment. For example, the user 105 may operate the user device 110, via a touch screen of the user device 110, input buttons, voice command, or the like, to activate a peer-to-peer payment function, such as by activating or starting the peer-to-peer payment. The peer-to-peer payment app may request that the user 105 enter various information, such as type of payment, payee information, type of payment arrangement, payment amount, payment account information, account ID, and the like. For example, the user 105 may input that the peer-to-peer payment is a one to one mobile payment to a nearby payee with the payee's email or mobile phone number. In another example, the user 105 may input that the peer-to-peer payment is for splitting a restaurant bill among four different users (including the user 105). The user 105 may input one or more user names, mobile phone numbers, and/or contact information of the nearby users with whom the user 105 intends to implement payment transactions. For example, the user 105 may select one or more users from the user 105's contact list.

In an embodiment, the user 105 may initiate a payment group and may invite nearby users to join the payment group using their mobile devices. The user 105 may input a name for the payment group, such as based on the purpose, location, or group of the users. For example, the user 105 may create a payment group for splitting a lunch bill at a restaurant and may name the payment group: “XXX lunch bill split” with “XXX” as the name of the restaurant or the name of the group.

At step 204, the user device 110 may detect nearby wireless devices via short-range wireless communication. In particular, the user device 110 may generate and broadcast a short-range wirelesssignal to invite nearby mobile devices to connect to the user device 110 and/or to join the payment group. The short-range wirelesssignal may carry a data packet including the name of the payment group, or the name of the user 105 or user device 110, as defined by the peer-to-peer mobile payment short-range wirelessprofile. The short-range wirelesssignal may be discoverable by other devices with a short-range wireless profile for peer-to-peer mobile payments.

The peer-to-peer mobile payment short-range wireless profile may define the formats and rules for communication between mobile devices to implement peer-to-peer mobile payments via short-range wireless communication. In particular, the peer-to-peer mobile payment short-range wireless profile may define a unique short-range wireless signature (in a data packet) for broadcasting and/or discovering short-range wireless signals requesting for joining/connecting to a payment group to implement peer-to-peer mobile payments. Further, the peer-to-peer mobile payment short-range wireless profile may define data formats and rules for the mobile devices to communicate and negotiate a payment arrangement. The host device, such as user device 110, may act as the facilitator to coordinate the peer-to-peer mobile payment process. For example, the user device 110 may receive data packets from the slave devices, such as user devices 108, 112, and 116, indicating the other users' input or comments on a payment arrangement. The user device 110 may synthesize their input and may push out data packets to the respective user devices 108, 112, and 116 indicating the current state of the payment arrangement in real time. Thus, the users of a payment group may negotiate to reach an agreement in real time via the short-range wireless communication.

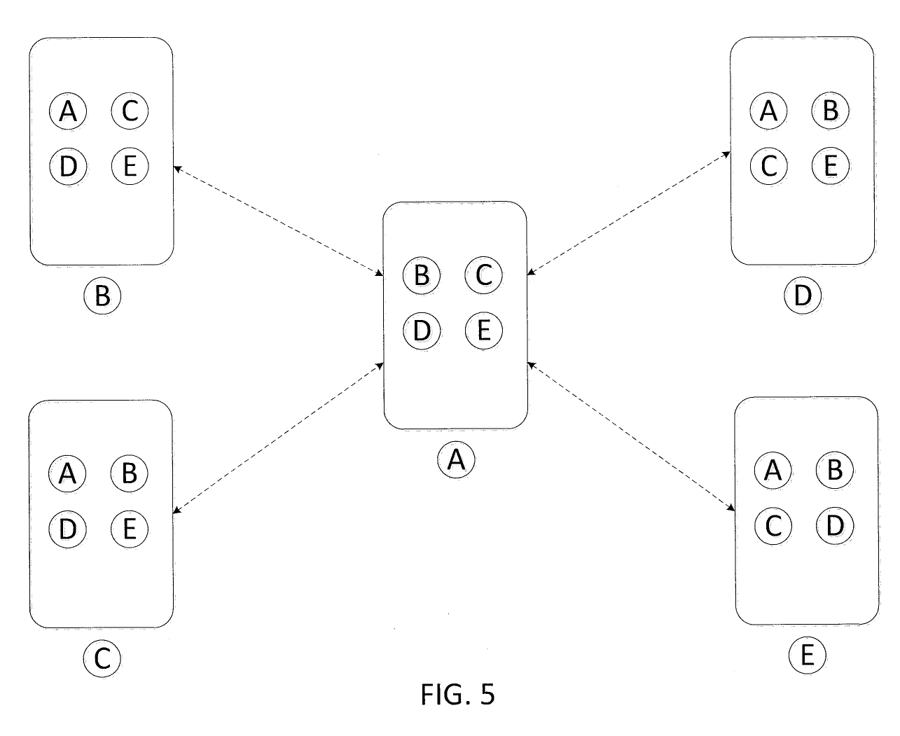

For example, as shown in FIG. 5, a device of user A may be the host device from which a peer-to-peer payment transaction is requested. The device of user A may broadcast a short-range wireless signal that is a Bluetooth signal to nearby devices of users B, C, D, and E. In an embodiment, the device of user A may detect and display nearby devices of users B, C, D, and E and devices of other users. Assuming that users B, C, D, and E are the intended participants of the payment group, user A may select the devices of users B, C, D, and E to join user A's payment group. In some embodiments, the peer-to-peer mobile transaction app may obtain additional information about nearby users from payment provider server 170, such as pictures of nearby users for better identification purpose. For example, the peer-to-peer mobile transaction app may detect/receive device/account identifiers of nearby users via short-range wireless communication and may use these identifiers to obtain additional information from payment provider server 170 via internet connection. This may be implemented when network connection to the payment provider server 170 or another server is available.

In order to ensure that the payment group is joined by only the intended user devices, the peer-to-peer mobile payment app may generate a participation code, such as a numeral or character string. The participation code may be displayed to the user 105, or the initiator of the payment group. The user 105 may communicate this participation code to the intended users, such as verbally. The intended users may then use the participation code to access and/or join the payment group or to connect to the user device 110. For example, the user device 110 may receive a response from a nearby mobile device requesting to join the payment group. The response or request to join the payment group from the nearby mobile device may include a code. The user device 110 may verify that the request to join the payment group includes a code that matches the participation code of the payment group. If verified, the user device 110 may allow the nearby mobile device to join the payment group by connecting to (pair with) the user device 110 (via short-range wireless communication).

In an embodiment, the peer-to-peer mobile payment app may provide instructions on how to invite other users to join a payment group. The peer-to-peer mobile payment app may require that all intended users perform a certain gesture simultaneously to join the payment group. For example, the user 105 and the intended users may be instructed to operate their respective mobile devices at the same time, such as push a certain button in their peer-to-peer mobile payment app within a time window (e.g., within five seconds), in order to join the payment group. In another example, the user 105 and the intended users may be instructed to bump or physically contact their respective mobile devices to each other to join the payment group. The bumping or physical contact of mobile devices may in some cases be detected by a proximity sensor or by Near Field Communication (NFC) connections between the mobile devices. In still another example, the user 105 and the intended users may be instructed to perform a certain gesture on the touch screens of the respective mobile devices, such as finger tracing of a dollar sign ($) or a letter P for payment. The user device 110 may verify that the user 105 and/or the other nearby users perform the required gesture or actions on their respective mobile devices (e.g., within a required window of time). The user device 110 may connect the user device 110 and the other user devices when their gestures or actions are verified.

In an embodiment, the peer-to-peer mobile payment app on the user device 110 may generate a scannable code, such as a bar code or a Quick Response (QR) code. The scannable code may be displayed on the user device 110. The user 105 may present the scannable code on the user device 110 to the intended users. The intended users may use their respective mobile devices to scan the scannable code to join the payment group. For example, the user device 110 may receive a response from a nearby mobile device requesting to join the payment group. The response or request to join the payment group from the nearby mobile device may include a code derived from a scannable code. The user device 110 may verify that the request to join the payment group includes a code that matches the participation code of the payment group. If verified, the user device 110 may allow the nearby mobile device to join the payment group by connecting to (pair with) the user device 110 (via Bluetooth communication).

The various embodiments described above may allow the user 105 to restrict the payment group to the intended users. As such, other nearby users who are not given access to the payment group may not join the payment group. For example, the user 105 with the user device 110 may be located inside a crowded restaurant with many other customers. The user 105 may wish to invite only customers sitting at the same table to join a payment group to split a bill. Thus, the user 105 may restrict the payment group to only the users sitting at the same table by using the above-discussed techniques.

At step 206, the peer-to-peer mobile payment app may establish the peer-to-peer payment group by connecting the intended user devices to the user device 110. For example, user devices 108, 112, and 116 may be the intended user devices and may be connected to (or paired with) the user device 110 via short-range wireless communication. The communication may be implemented according to the peer-to-peer mobile payment short-range wireless profile. Thus, the peer-to-peer mobile payment app may allow a user to create a dynamic payment group in real time. The payment group may be connected by an ad hoc wireless network via short-range wireless communication. The short-range wireless communication may allow the user 105 and the uses of the user devices 108, 112, and 116 to negotiate and establish a payment arrangement.

At step 208, the peer-to-peer mobile payment app may determine payment arrangement for the payment group. In an embodiment, the user 105 may propose a payment arrangement and the other users may agree or accept the payment arrangement. In some embodiments, the other users may be allowed to offer or propose an alternate payment arrangement different from the user 105's proposed payment arrangement. The peer-to-peer mobile payment app may allow the user 105 and the other users to operate their respective mobile devices to discuss and negotiate a payment arrangement via short-range wireless communication. For example, the peer-to-peer mobile payment app may provide an interface in each of the participating devices that allows the users to determine a payment arrangement.

In an embodiment, the peer-to-peer mobile payment app may provide several default payment arrangements that are popular or frequently used by customers. For example, the peer-to-peer mobile payment app may have several default payment arrangements, such as an option for splitting a bill. The peer-to-peer mobile payment app may allow the users to split a bill evenly among the users of the payment group by default. The peer-to-peer mobile payment app may allow the user to negotiate and modify the percentage or amount shared by each user. For example, a graphical user interface may utilize a pie chart or bar graph to indicate each user's amount/percentage share of the bill. The users may interact with the pie chart or bar graph to adjust and/or negotiate their respective share of the bill, such as by moving the portion dividing lines in the pie chart or the bar graph to change the users' shares of the bill. The users in the payment group may discuss and negotiate to reach an agreement on the payment arrangement.

In an embodiment, the peer-to-peer mobile payment app may provide a gaming interface for determining the payment arrangement. The gaming interface may receive input from the users in the payment group and may determine payment arrangement based on the users' input. For example, the users may play a game in which the users may compete to win a reduced share of the bill. The game may allow the user to determine who touches a payment button first to win a reduced share of the bill. In another example, the gaming interface may use a random factor to determine a winner. For example, the games may include spinning a wheel that may introduce a random factor in determining a winner for reduced share of the bill. Other games may include rolling a dice, trivia games, and the like. The gaming interface may introduce fun and competitiveness among the users.

In an embodiment, the peer-to-peer mobile payment app may determine the payment arrangement based on the users' payment history. For example, the users may regularly go out to lunch together and may wish to take turns paying for lunch. Thus, the peer-to-peer mobile payment app may record and analyze the payment history of the users in a particular group and may determine whose turn it is to pay the bill this time. For example, some embodiments may determine that user A, user B, and user C are present in a current payment group, and that this combination of users has been used in a number of prior payment groups. Based on the history of those other payment groups, and in some cases user-specified preferences, the peer-to-peer mobile payment app may determine the current payment group will likely prefer for user C to pay for the current bill. This determination may in some cases be based on user C consistently paying for the bill in prior groups; user A, user B, and user C rotating payment of the bill in prior groups, other detected patters, and/or user-specified rules.

In an embodiment, the payment arrangement may be determined based on certain priority order of the users in the payment group, such as by age, organization rank, or the like. For example, the bill may be split based on age such that an older person pays more than a younger person. In another example, the users may agree that the type of priority be randomly selected in a game, such that the peer-to-peer mobile payment app may randomly select from different types of priority orders, such as priority by age, rank, and the like.

At step 210, the user device 110 may process the peer-to-peer mobile payment transaction(s) based on the payment arrangement, as determined in step 208. In particular, the user device 110 may generate one or more payment transaction requests based on the payment arrangement. For example, the payment arrangement may indicate that the users agree to split a bill at a restaurant in which user A will pay the total amount of the bill to the restaurant and users B, C, D, and E will each pay 20% of the bill to user A. Thus, five different payment requests may be generated: 1. User A's payment to the restaurant; 2. 20% payment from user B to user A; 3. 20% payment from user C to user A; 4. 20% payment from user D to user A; and 5. 20% payment from user E to user A. For example, the device of user A may send payment requests to devices of users B, C, D, and E with amount details and user A's account information (account number, account ID, email address, etc.) to receive payments from users B, C, D, and E. Devices of users B, C, D, and E may receive the payment information from the device of user A and may initiate their respective payments to user A. The devices of users B, C, D, and E may respectively send their payment transaction request to payment provider server 170, if network connect is available.

The user device 110 may communicate the generated payment transaction requests to the payment provider server 170 via the network 160. Payment provider server 170 may process the payment transaction requests accordingly by debiting from respective payers' accounts and crediting respective payees' accounts. In an embodiment, the user device 110 may not have network connection to the payment provider server 170. In this case, the user device 110 may temporarily store the payment transaction requests at the user device 110 and may later transmit the payment transaction requests to the payment provider server 170 when network connection becomes available. This may allow the users to conduct peer-to-peer mobile payment transactions among the user devices via short-range wireless communication even when network connection to the payment provider server 170 is not available.

In an embodiment, when the user device 110 does not have adequate network connection to payment provider server 170, the user device 110 may determine, from the connected user device 108, 112, and 116, another user device that has adequate network connection to the payment provider server 170. The user device 110 may communicate the generated payment transaction requests via short-range wireless communication to another user device in the payment group that has adequate network connection to the payment provider server 170. Thus, the user device with adequate network connection may be used to communicate the payment transaction requests to the payment provider server 170.

As noted above, user device 110 may execute process 200 to initiate and establish a payment group via short-range wireless communication. The peer-to-peer mobile payment app may provide an interface for users in the payment group to negotiate and agree to a payment arrangement. Payment transaction requests may be generated based on the payment arrangement to be processed by the payment provider server 170. In an embodiment, the payment transaction requests may be stored temporality at the user device when network connectivity is not available. The payment transaction requests may later be communicated to the payment provider server 170 when network connection becomes available.

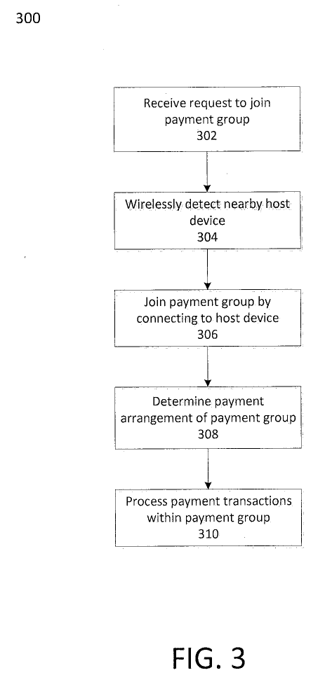

FIG. 3 is a flowchart showing a process 300 for joining or participating in a peer-to-peer payment transaction. The following description is an example of a user of user device 108 participating in a payment group initiated by user device 110. At step 302, the user device 108 may receive a request from its user for joining a payment group for peer-to-peer mobile payments. For example, the user may activate a peer-to-peer mobile payment app on the user device 108 to request to join a payment group. Other ways to request to join a payment group may include performing particular gestures on the user device 108, such as drawing a dollar sign on the touch screen or by voice command.

At step 304, in response to the request, the user device 108 may begin to detect or discover nearby mobile devices that are hosting a payment group, such as user device 110. In particular, the user device 108 may detect short-range wireless signals that are broadcast and include signatures designated for peer-to-peer mobile payment. Assuming that user device 110 is broadcasting a short-range wireless signal inviting other devices to join a payment group and user device 108 is located within the broadcast range of user device 110, user device 108 may detect the short-range wireless signal and may respond to join the payment group. In particular, the peer-to-peer mobile payment app may provide instructions on how to join the payment group. For example, the instructions may require that the user of user device 108 obtain a code from the user of user device 110, such as via verbal communication or by scanning a code from the user device 110. In other examples, the instructions may require that the user of user device 108 perform certain actions or gestures using user device 108 to join the payment group, such as bumping the user device 108 to user device 110, push and hold a button on user device 108, or draw a certain symbol/character on the touch screen of user device 108. As described in steps 204 and 206, various ways may be implemented to verify and connect nearby user devices to user device 110. In other embodiments, the payee may share payment group information verbally with nearby payers. The payer may then perform action to join the payment group on their device by entering the shared information. The payer's device may broadcast its identity (via Bluetooth) along with the payment group information. The payee's device may listen/scan for the broadcast messages. When the payee's device receives the message, the message may be validated with the payment group information and the payee's device may be connected to the payer's device. As such, the payer's device becomes part of the payment group created by the payee. The payee may then send payment transaction request to the payer.

At step 306, if the code or the actions of the user is verified, user device 108 may be included in the payment group and connected to (paired with) user device 110 via Bluetooth communication for peer-to-peer mobile payments. Multiple user devices, such as user devices 108, 112, and 116, may be included in the payment group and connected to the user device 110 at the same time to implement peer-to-peer mobile payments. In an embodiment, the peer-to-peer mobile payment app on user device 108 may provide a graphical interface showing uses who are currently in the payment group.

At step 308, user device 108 may interact with user device 110 to determine a payment arrangement of the payment group. User device 108 may provide the user with a user interface that allows the user to input and interact with the other users in the payment group in negotiating to reach an agreement on a payment arrangement. Similar to step 208 in process 200, the peer-to-peer mobile payment app on user device 108 may provide various options and interfaces for the users to work out a payment arrangement, including a graphical interface and/or a gaming interface.

At step 310, the peer-to-peer mobile payment app may process payment transactions based on the payment arrangement, as agreed to by the users in the payment group. Similar to step 210 of process 200, payment transaction requests may be generated based on the payment arrangement. The payment transactions requests may be communicated to the payment provider server 170 to be processed. When network connection is not available, the payment transactions requests may be stored temporarily at the hosting device, such as user device 110 and later be communicated to the payment provider server 170 when network connection becomes available. In another embodiment, the payment transaction requests may be stored temporarily at the respective payers' user devices. For example, a payment transaction request to pay user A from user B may be stored at user B's device. In still another embodiment, the payment transaction requests may be stored temporality at the respective payees' user devices. For example, a payment transaction request to pay user A form user B may be stored at user A's device.

By using the above systems and methods, peer-to-peer mobile payment transactions may be conducted directly between mobile devices via peer-to-peer short-range wireless communication. A peer-to-peer mobile payment app may be provided to connect and coordinate various nearby mobile devices such that users may form dynamic payment group and negotiate to reach a payment arrangement in real time. The peer-to-peer mobile payment transactions may be conducted over peer-to-peer short-range wireless communication, even when network connection to the payment provider server is not available.

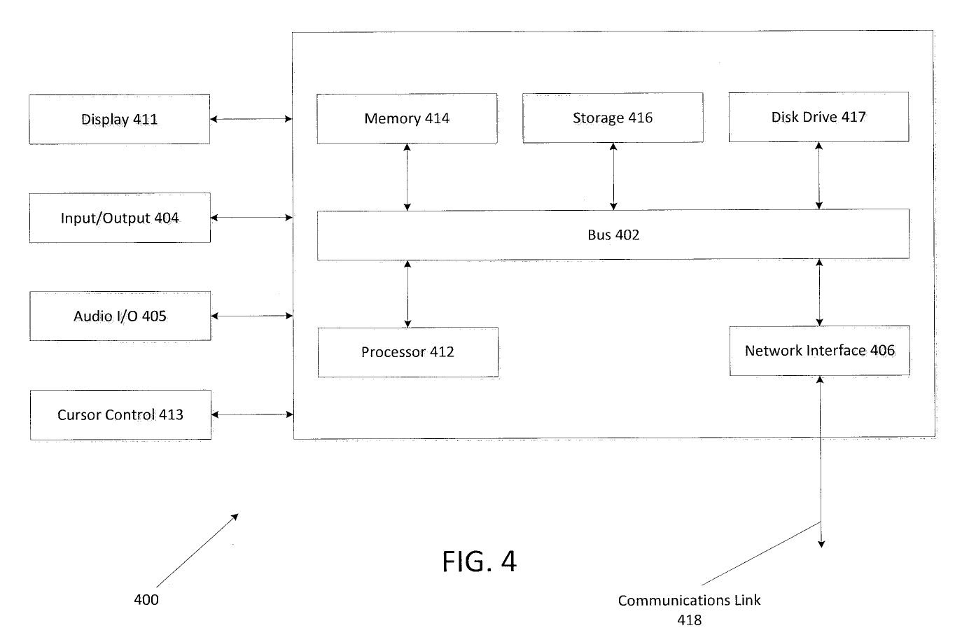

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with other communication devices and the network 160. The merchant and/or payment provider may utilize a network computing device (e.g., a network server) capable of communicating with other communication devices and the network 160. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. For example, the description focused on payments, payment apps, and payment providers. However, other action, apps, and entities may be used, such as more generalized electronic/digital transactions between mobile devices, including data transfers, content transfers, virtual currencies, token sharing, reward mileage/point transactions/sharing, credit/debt exchange/transactions, and the like. Thus, the present disclosure is limited only by the claims.

What is claimed is:

1. A peer-to-peer mobile transaction device comprising:
a display device configured to display a user interface for implementing peer-to-peer mobile transactions;
a user input device configured to receive user instructions for a peer-to-peer mobile transaction;
a non-transitory memory configured to store information related to an account of a user of the peer-to-peer mobile transaction device; and
one or more hardware processors coupled to the non-transitory memory and configured to read instructions form the non-transitory memory to cause the peer-to-peer mobile transaction device to perform operations comprising:
receiving, by the user input device, a request from the user to conduct a peer-to-peer transaction;
communicating, between another mobile device and the mobile device, information for establishing a transaction arrangement between the user and another user of the another mobile device;
displaying, by the display device, the transaction arrangement on the user interface; and
facilitating, the peer-to-peer transaction based on the transaction arrangement.

2. The peer-to-peer mobile transaction device of claim 1, wherein the operations further comprise:
receiving, via the user input device, a request from the user to establish a payment group;
broadcasting a wireless signal inviting nearby mobile devices to join the payment group;
receiving a request from the another mobile device to join the payment group; and
receiving the another mobile device into the payment group.

3. The peer-to-peer mobile transaction device of claim 2, wherein the broadcasting the wireless signal includes broadcasting a Bluetooth signal for a particular period of time within which the payment group is available for the nearby mobile devices to join.

4. The peer-to-peer mobile transaction device of claim 2, wherein the operations further comprise:
generating a code for the payment group; and
verifying that the request from the another mobile device to join the payment group includes the code.

5. The peer-to-peer mobile transaction device of claim 2, wherein the request from the another mobile device to join the payment group comprises information indicating a particular gesture performed by the another user at the another mobile device and the operations further comprise verifying that the particular gesture matches a designated gesture for joining the payment group.

6. The peer-to-peer mobile transaction device of claim 5, wherein the particular gesture comprises contacting the another mobile device with the peer-to-peer mobile payment device.

7. The peer-to-peer mobile transaction device of claim 5, wherein the particular gesture is made by the another user on a touch screen of the another mobile device.

8. The peer-to-peer mobile transaction device of claim 1, wherein the operations further comprise:
detecting that a network connection to a payment service provider is not available; and
storing information of the peer-to-peer transaction for later upload to the payment service provider when the network connection becomes available.

9. A method for facilitating peer-to-peer mobile payment, the method comprising:
receiving, by an user input device of a first mobile device, a request from a user of the first mobile device to conduct a peer-to-peer payment transaction;
connecting, by the first mobile device, the first mobile device to a second mobile device;
facilitating, by the first mobile device, communication between the first mobile device and the second mobile device, information for establishing a payment arrangement between the user of the first mobile device and another user of the second mobile device;
displaying, by a display device of the first mobile device, a user interface including the payment arrangement; and
facilitating the peer-to-peer payment transaction based on the payment arrangement.

10. The method of claim 9, further comprising:
receiving, by the user input device of the first mobile device, a request from the user to join a payment group;
detecting, by the first mobile device, a Bluetooth signal from the second mobile device inviting the user of the first mobile device to join the payment group;
detecting a particular gesture performed by the user at the first mobile payment device; and
communicating, by the first mobile device, the request to join the payment group and information indicating the particular gesture to the second mobile device; and
receiving, by the first mobile device, a confirmation from the second mobile device that the first mobile device is included into the payment group.

11. The method of claim 9, further comprising:
receiving, by the user interface of the first mobile device, input from the user for establishing the payment arrangement; and
establishing the payment arrangement based on the input from the user and input from the another user of the second mobile device.

12. The method of claim 9, wherein the payment arrangement comprises splitting a bill between the user and the another user.

13. The method of claim 9, further comprising:
providing a gaming interface for determining the payment arrangement;
receiving input from the user and the another user via the gaming interface; and
determining the payment interface based on the input from the user and the another user.

14. The method of claim 13, wherein the gaming interface provides a randomized selection of a payer from the user and the another user.

15. The method of claim 9, wherein the payment arrangement is determined based on a payment history of the user and the another user.

16. The method of claim 9, further comprising:
detecting that a network connection to a payment service provider is not available; and
storing information of the peer-to-peer payment transaction for later upload to the payment service provider when the network connection becomes available.

17. A non-transitory machine-readable medium having stored thereon machine-readable instruction executable to cause a machine to perform operations comprising:
receiving, by an user input device of a first mobile device, a request from a user of the first mobile device to conduct a peer-to-peer payment transaction;
connecting, by the first mobile device, the first mobile device to a second mobile device;
facilitating, by the first mobile device, communication between the first mobile device and the second mobile device, information for establishing a payment arrangement between the user of the first mobile device and another user of the second mobile device;
displaying, by a display device of the first mobile device, a user interface including the payment arrangement; and
facilitating the peer-to-peer payment transaction based on the payment arrangement.

18. The non-transitory machine-readable medium of claim 17, wherein the operations further comprise:
receiving, via the user input device, a request from the user to establish a payment group;
broadcasting a Bluetooth signal inviting nearby mobile devices to join the payment group;
receiving a request from the second mobile device to join the payment group; and
receiving the second mobile device into the payment group.

19. The non-transitory machine-readable medium of claim 17, wherein the operations further comprise:
receiving, by the user input device of the first mobile device, a request from the user to join a payment group;
detecting, by the first mobile device, a Bluetooth signal from the second mobile device inviting the user of the first mobile device to join the payment group;
detecting a particular gesture performed by the user at the first mobile payment device; and
communicating, by the first mobile device, the request to join the payment group and information indicating the particular gesture to the second mobile device; and
receiving, by the first mobile device, a confirmation from the second mobile device that the first mobile device is included into the payment group.

20. The non-transitory machine-readable medium of claim 17, wherein the operations further comprise:
detecting that a network connection to a payment service provider is not available; and
storing information of the peer-to-peer payment transaction for later upload to the payment service provider when the network connection becomes available.
